(19) United States
(12) Patent Application Publication
(10) Pub. No.: US 2009/0197048 A1
(43) Pub. Date: Aug. 6, 2009

(54) DAMAGE RESISTANT GLASS ARTICLE FOR USE AS A COVER PLATE IN ELECTRONIC DEVICES

(76) Inventors: Jaymin Amin, Corning, NY (US); Adra Smith Baca, Rochester, NY (US); Lorrie Foley Beall, Painted Post, NY (US); Robert Alan Bellman, Painted Post, NY (US); Mike Xu Ouyang, Painted Post, NY (US); Robert Sabia, Corning, NY (US)

Correspondence Address: CORNING INCORPORATED, SP-TI-3-1, CORNING, NY, 14831, US

(21) Appl. No.: 12/366,267

(22) Filed: Feb. 5, 2009

Related U.S. Application Data
(60) Provisional application No. 61/026,289, filed on Feb. 5, 2008.
(60) Provisional application No. 61/130,532, filed on May 30, 2008.

(51) Int. Cl. B32B 5/00; B32B 17/06; B32B 7/02; B05D 5/06

(52) U.S. Cl. 428/142; 428/426; 428/428; 428/220; 428/337; 428/215; 427/165

(57) ABSTRACT

An alkali aluminosilicate glass article, said alkali aluminosilicate glass having a surface compressive stress of at least about 200 MPa, a surface compressive layer having a depth of at least about 30 μm, a thickness of at least about 0.3 mm and an amphiphobic fluorine-based surface layer chemically bonded to the surface of the glass. In one embodiment the glass has an anti-reflective coating applied to one surface of the glass between the chemically strengthened surface of the glass and the amphiphobic coating. In another embodiment the surface of the chemically strengthened glass is acid treated using a selected acid (e.g., HCL, H₂SO₄, HClO₄, acetic acid and other acids as described) prior to placement of the amphiphobic coating or the anti-reflective coating.

### CROSS-REFERENCE TO RELATED APPLICATIONS

This application claims the benefit of priority under 35 U.S.C. § 119(e) of U.S. Provisional Application Ser. No. 61/026,289 filed on Feb. 5, 2008 and claims the benefit of priority under 35 U.S.C. § 119(e) of U.S. Provisional Application Ser. No. 61/130,532 filed on May 30, 2008.

### FIELD

The invention relates to an alkali aluminosilicate glass. More particularly, the invention relates to a high strength, down-drawn alkali aluminosilicate glass article for use a protective cover plate. Even more particularly, the invention relates to a high strength, down-drawn alkali aluminosilicate amphiphobic glass for use as a cover plate in mobile electronic devices.

### TECHNICAL BACKGROUND

Mobile electronic devices, such as personal data assistants, mobile or cellular telephones, watches, laptop computers and notebooks, and the like, often incorporate a cover plate. At least a portion of the cover plate is transparent, so as to allow the user to view a display. For some applications, the cover plate is sensitive to the user's touch. Due to frequent contact, such cover plates must have high strength and be scratch resistant.

U.S. patent application Ser. No. 11/888,213 assigned the instant assignee discloses alkali aluminosilicate glass that is capable being chemically strengthened by ion-exchange and exhibits a composition which can be down-drawn into sheets. The glass has a melting temperature of less than about 1650° C. and a liquidus viscosity of at least 130 kpoise and, in one embodiment, greater than 250 kpoise. The glass can be ion-exchanged at relatively low temperatures and to a depth of at least 30 μm. Compositionally the glass comprises: 64 mol %≦SiO₂≦68 mol %; 12 mol %≦Na₂O≦16 mol %; 8 mol %≦Al₂O₃≦12 mol %; 0 mol %≦B₂O₃≦3 mol %; 2 mol %≦K₂O≦5 mol %; 4 mol %≦MgO≦6 mol %; and 0 mol %≦CaO≦5 mol %, wherein: 66 mol %≦SiO₂+B₂O₃+CaO≦69 mol %; Na₂O+K₂O+B₂O₃+MgO+CaO+SrO>10 mol %; 5 mol %≦MgO+CaO+SrO≦8 mol %; (Na₂O+B₂O₃)—Al₂O₃≦2 mol %; 2 mol %≦Na₂O—Al₂O₃≦6 mol %; and 4 mol %≦(Na₂O+K₂O)—Al₂O₃≦10 mol %.

This alkali aluminosilicate glass can be used as a damage resistant cover glass for use in electronic products. The glass is finished to shape and then chemically tempered, or ion-exchanged (IOXed), to form a compressive surface layer that prevents mechanical damage such as scratching and abrasion, thus imparting damage resistance. The IOX process works by exchanging larger potassium ions for smaller sodium ions at the surface of the glass, with time and temperature of the process driving the depth of exchange and imparting a compressive “depth of layer” (DOL) that, if deeper than damage induced to the surface during product use, prevents breakage. Adding to the benefits of this product is that IOXed alkali aluminosilicate glass and can be IOXed to greater DOLs than competitive glasses, thus minimizing damage and preventing failure, respectively.

However, there are several critical issues for this alkali aluminosilicate glass (and all competitive cover glass articles) regarding their use in applications such as a cover glasses for media/electronic devices. One critical issue is the inability to prevent the transference of and difficulty in removing oils and greases transferred to the surface by fingerprints. The difficulty in removing the oil and greases is particularly important in applications such as touch screens, where fingerprints are repeatedly applied to the cover glass surface when the device is in-use. The transferred fingerprints, as well as smudges that may arise from other sources, appear on the screen, particularly when a dark or black background appears, for example, when the device is not in use. This leads to concerns about optical interference by the fingerprints/smudges which can impact the picture quality (degrades its appearance) and create negative perceptions of the device in the customer. Included in the fingerprint oils and greases are dirt, cosmetics, and lotions.

A second critical issue is glare that can arise from reflections on the display surface. Glare arises from the reflection of light that is not normal to the field of the operator's view. The presence of glare causes the use to tilt the device and continually adjust the screen angle for better viewing. Having to constantly change their angle of viewing is irksome to the user and creates dissatisfaction. Furthermore, any display surface that includes anti-reflection (“AR”) properties would make fingerprints more evident, as tilting of non-AR coated surfaces negates out fingerprints with glare. Thus, the need for an “anti-fingerprint” or “easy-to-clean” coating is of higher importance for anti-reflective surfaces.

Although some industrial coatings exist that offer a degree of surface protection by minimizing fingerprint adherence via improved oil/water wetting behavior, no such coating has been successfully applied for chemically toughened glass for touch-screen applications.

### SUMMARY

The invention in one embodiment relates to a product consisting of a transparent, damage resistant, chemically toughened protective cover glass (also called a cover plate or cover screen) that has an exterior coating having fluorine termination groups that impart a degree of hydrophobicity and oleophobicity (i.e., amphiphobicity) to the cover glass such that wetting of the glass surface by water and oils is minimized. (Amphiphobic substances thus lack an affinity for both oils and water.) The coated product has scratch, abrasion, and other damage resistance imparted by the compressive surface DOL of the glass, and additionally has anti-fingerprint, anti-smudge characteristics imparted by the fluorine termination groups that minimize the transport of oils from finger to the glass (fingerprints) and further allows for ease of removal of the oils/fingerprints by means of wiping with a cloth. In a further embodiment the invention relates to a product consisting of a transparent damage resistant chemically protective cover glass having at least one chemically toughened layer and a non-chemically toughened layer; said cover glass having a exterior coating of fluorine termination groups that impart a degree of hydrophobicity and oleophobicity. In a further embodiment the invention relates to a product consisting of a transparent damage resistant chemically protective cover glass having a non-chemically toughened layer sandwiched between two chemically toughened layers and; said cover glass having a exterior coating of fluorine termination groups that impart a degree of hydrophobicity and oleophobicity. The chemical toughened layers are formed by ion exchange of Na and/or Li ions by K ions. Hence, for example, the cover glass may have a non chemically toughened layer sandwiched between two chemically toughened layers in which Na and/or Li ions have been exchanged by K ions.

The present invention provides an alkali aluminosilicate glass article having a thickness of at least approximately 0.3 mm, a surface compressive stress of at least about 200 MPa, a surface compressive layer having a depth of at between approximately 20-70 μm, and having an amphiphobic adsorbed fluorine-based surface layer.

The adsorbed fluorine-based surface layer is formed by exchanging the hydrogen of glass terminal OH groups with a fluorine-based moiety, for example a fluorine containing monomer, to form a glass having terminal fluorinated groups. For example without limitation, the exchange can be carried out according to the reaction

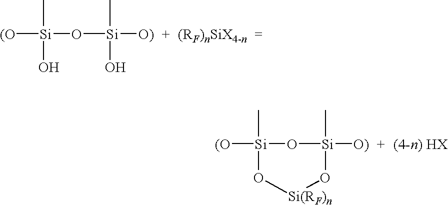

where R_{F} is a C₁-C₂₂ alkyl perfluorocarbon or C₁-C₂₂ alkyl perfluoropolyether, preferably C₁-C₁₀ alkyl perfluorocarbon and more preferably a C₁-C₁₀ alkyl perfluoropolyether; n is an integer in the range of 1-3; and X is a hydrolyzable group that can be exchanged with the glass terminal OH groups. Preferably, X is a halogen other than fluorine or an alkoxy group (—OR) where R is a linear or branched hydrocarbon of 1-6 carbon atom, for example without limitation, —CH₃, —C₂H₅, —CH(CH₃)₂ hydrocarbons. In some embodiments n=2 or 3, preferably 3. The preferred halogen is chlorine. A preferred alkoxysilane is a trimethoxy silane, R_{F}Si(OMe)₃. Additional perfluorocarbon moieties that can be used in practicing the invention include (R_{F})₃SiCl, R_{F}—C(O)—Cl, R_{F}—C(O)—NH₂, and other perfluorocarbon moieties having a terminal group exchangeable with a glass hydroxyl (OH) group. As used herein the terms “perfluorocarbon”, “fluorocarbon” and perfluoropolyether means a compound having hydrocarbon groups as described herein in which substantially all of the C—H bonds have been converted into C—F bonds.

In another embodiment the adsorbed fluorine-based surface layer is comprised of an assembled monolayer of a fluorine-terminating molecular chain. In a still further embodiment the adsorbed fluorine-based surface layer is comprised of a thin, fluoro-polymeric coating. In a final embodiment the adsorbed fluorine-based surface layer is comprised of silica soot particles having pendent fluorocarbon groups attached to the soot particles.

The invention, in a further embodiment, relates to a product consisting of a transparent, damage resistant, chemically toughened protective cover glass that has an anti-reflective layer, for example without limitation, an anti-reflective SiO₂ or F—SiO₂ (fluorine doped silica or fused silica) layer, and further has an exterior coating having fluorine termination groups that impart a degree of hydrophobicity and oleophobicity (i.e., amphiphobicity) to the cover glass such that wetting of the glass surface by water and oils is minimized. Abrasion resistance is imparted to the anti-reflective article by applying a final coating of an amphiphobic material as described herein. The amphiphobic material coated product has scratch, abrasion, and otherwise damage resistance imparted by the compressive surface DOL of the glass, and additionally has anti-fingerprint, anti-smudge characteristics imparted by the fluorine termination groups that minimizes the transport of oils and sweat from finger to the glass (fingerprints) and further allows for ease of removal of the oils/fingerprints by means of wiping with a cloth. The AR coating can have a lower abrasion/scratch resistance than the underlying chemically strengthened base glass. Coating the Ar-coated chemically strengthened glass with an amphiphobic material imparts abrasion resistant properties to the AR-coated glass and thus enables the AR-coated glass to regain the performance of the base glass while further giving the AR-coated glass anti-fingerprint, anti-smudge characteristics. In preferred embodiments the exterior (outermost) layer of the AR coating is a SiO₂-containing layer; for example F—SiO₂, fused silica or silica.

Additionally, the alkali aluminosilicate glass article may further include a textured or patterned surface located between base glass and the fluorine-based surface coating layer. Texture can be derived by acid/alkali etch including combinations thereof, to produce a roughness in the range of 50 nm to 5 μM (5000 nm) in RMS roughness, the composition of the roughened glass at near-surface preferably being rich in SiO₂. The roughness can be measured by techniques such as Atomic Force Microscopy (“AFM”) and Scanning White Light Interferometry (SWLI). Alternatively, the texture can be derived lithographically or using otherwise deposited structures, again with the composition of the roughened glass at near-surface preferably being rich in SiO₂. After the textured layer is formed, the textured layer and any untextured base glass is then coated with a fluorine-containing materials as described herein to form an article having a textured, fluorine-containing material coated article.

These and other aspects, advantages and salient features of the present invention will become apparent from the following detailed description, the accompanying drawings, and the appended claims.

### BRIEF DESCRIPTION OF THE DRAWINGS

FIG. 1 is a schematic of the alkali aluminosilicate glass article according to one embodiment and illustrates an article in which a layer of an amphiphobic perfluorocarbon or perfluorocarbon containing moiety is covalently bonded to the surface of a chemically strengthened glass.

FIG. 2 is a schematic of a chemically strengthened alkali aluminosilicate glass article according to a second embodiment and illustrates an article in which a textured or patterned surface is present and an amphiphobic layer is covalently bonded to the surface of a chemically strengthened glass including the textured area.

FIG. 3 is a schematic of an alkali aluminosilicate glass according to an additional embodiment of the invention and illustrates an article in which at least one layer of an anti-reflective material is placed on top a chemically strengthened glass layer and an amphiphobic coating layer is covalently bonded to the surface of the anti-reflective coating.

FIG. 4 is a schematic illustrating the generic process flow for preparing glass surfaces for coating with an amphiphobic coating.

FIG. 5A illustrates wiping performance to reduce haze and thus improve optical clarity of coated glass versus non-coated glass.

FIG. 5B shows the cover glass represented in FIG. 5A, left side uncoated and right side coated, after fingerprint oil has been applied and wiped.

FIG. 5C shows a cover glass, left side uncoated and right side coated, after abrasion with 150 grit sandpaper and wiping.

FIG. 6 illustrates the haze generated by abrasion with 150 grit sandpaper using coated glass and non-coated glass.

FIG. 7 illustrates the kinetic effect of friction, μ_{K}, of coated and non-coated glass surfaces.

FIG. 8 is a bar chart showing wiping results for a glass sample one-half treated with acid and one-half not acid treated, both halves being coated with an amphiphobic coating.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values includes both upper and lower limits of the range. The term “base glass” refers to any alkali aluminoborosilicate glass suitable for forming a protective cover glass before such glass undergoes ion-exchange or coating with any material, for example, an antireflective coating and/or a perfluorocarbon material or moiety to impart oil and smudge resistance. As used herein, the term “SiO₂ coating” means either a SiO₂ coating or F—SiO₂ coating, or a composite SiO₂/F—SiO₂ coating. In all embodiments described herein, the perfluorocarbon moiety or perfluorocarbon-containing moiety (as a layer or coating) is bonded to the surface of the glass, the chemically strengthened glass, or the chemically strengthened and SiO₂ (or F—SiO₂) coated glass by covalent bonds. Also herein the term “amphiphobic” is used to denote a material that when applied to a surface imparts both hydrophobic and oleophobic properties to the surface.

Referring now to FIG. 1, it will be understood that the illustration is for the purpose of describing a particular embodiment of the invention and is not intended to limit the invention thereto.

In general, what is disclosed is a transparent, protective cover glass article that has enhanced damage resistance and amphiphobic properties, thus providing a scratch resistance surface that exhibits minimal fingerprint adherence and ease of fingerprint removal.

FIG. 1 specifically illustrates alkali aluminosilicate glass article 100 having a thickness of at least 0.3 mm, a surface compressive stress layers 104 having a surface compressive stress of at least 200 MPa and middle glass layer 106. The surface compressive layer 104 has a thickness in the range of 20-70 μm; typically achieved through an ion-exchange process as described below. In addition to the surface compressive layer 104 and the non ion-exchanged middle layer glass portion 106, the article 100 has an amphiphobic adsorbed fluorine-based surface layer 102.

The adsorbed fluorine-based surface layer or coating can be achieved in any number of ways and can be selected from the group consisting of: (1) —OH group terminated active surface sites exchanged with a fluorine-based monomer; (2) an assembled monolayer of a fluorine-terminating molecular chain; (3) a thin, fluoro-polymeric coating; (4) silica soot particles which have been previous derived with or treated to have fluorine termination groups. The coating can be applied to the surface by dipping, vapor coating, spraying, application with a roller, or other suitable method. Dipping or spraying is preferred. After the coating has been applied it is “cured” at a temperature in the range of 25-150° C., preferably 40-100° C., a time in the range of 1-4 hours, in an atmosphere containing 40-95% moisture. The coating applied to the sample shown in the Figures and discussed herein was “50/50 cured,” meaning it was cured at 50° C. in an atmosphere containing 50% moisture for 2 hours. After curing the samples were solvent rinsed to remove any unbound coating and air-dried prior to use.

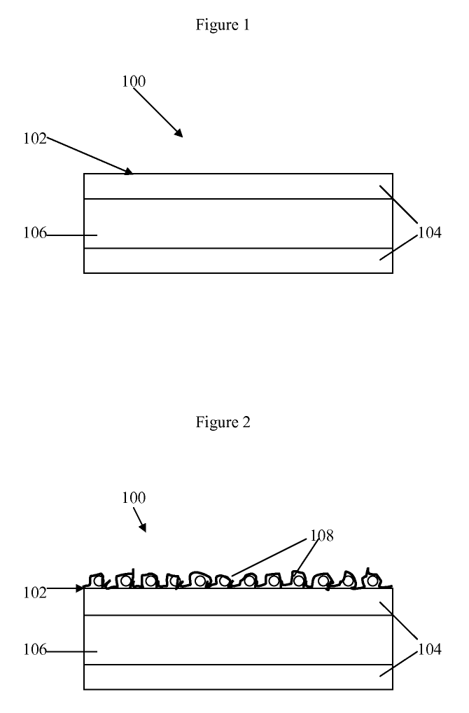

Referring now to FIG. 2, there is illustrated is another embodiment of the alkali aluminosilicate glass article 100. In this embodiment the glass article 100 includes all of the features of the FIG. 1 embodiment; including the surface compressive stress layer 104, the non ion-exchanged middle layer glass portion 106 and an amphiphobic adsorbed fluorine-based surface layer 102. In addition, this embodiment includes a textured or patterned surface 108 located between the adsorbed fluorine-based surface layer 102 (represented by the heavy black scribble line) and the glass surface compressive layer 104. In one embodiment the textured or patterned layer is formed from the compressive layer by etching or lithography. In another embodiment the textured or patterned layer is formed by particle coatings bonded to the compressive layer 104. The fluorine-based layer covers both the textured/patterned layer 104 and any compressive layer that has not been textured or patterned.

The textured or patterned surface illustrated in FIG. 2 is added to the base glass or is formed on the base glass. The application of this textured or patterned surface can be achieved in any number of ways known to those skilled in the art. Included among the options for adding the textured/patterned surface to the base glass or forming the textured/patterned surface on the base glass are etching, electrospinning of polymer or inorganic materials, a deposited inorganic film, ordered particle coatings, or any other means for patterning or texturing a glass surface known in the art. The inclusion of textured or patterned surface results in a glass article that exhibits increased surface area while maintaining the required degree of transparency. The textured surface is coated with an amphiphobic coating as described herein.

The combination of the fluorine surface treatment/layer and the enhanced surface roughness results in the enhancement of the glass article wetting properties. As a result the glass article exhibits minimized fingerprint adherence and maximized ease of removal for the fingerprint with limited smearing.

The amphiphobic glass articles disclosed herein exhibit the following enhanced features over commercially available protective cover glass solutions. The exemplary coating material used to prepare and test the samples described herein and in the Figures was DC 2604 (Dow Corning Corp, Midland, Mich.), an alkoxysilyl perfluoropolyether material. The test glass was Corning 1317 glass (Corning Incorporated, Corning N.Y.) which was chemically strengthened as described herein; and the test glass pieces had dimensions of approximately 2 cm×12 cm×0.4 cm.

Fingerprint Adherence. The fluorine treated (and thus fluorine terminated) surface is less polar than a surface with —OH termination groups, and thus promotes minimal hydrogen (i.e., Van der Waals) bonding between particles and liquids. For fingerprint oils and debris associated with fingerprints, bonding and thus adhesion are minimized, and as a direct result mass transport of oils and debris from the finger to the glass surface are minimized.

Cleaning and Cleanability. Removal of fingerprints is typically performed under dry or moist conditions by means of wiping the surface with a cloth. These cloths are reused, and can contain dirt and particles that may scratch the surface. The fluorinated surface of the product enhances ease of fingerprint removal while minimizing smudges and minimizing the amount of wiping applied. The latter further reduces the number and frequency of events that can induce damage to the surface, that can lead to immediate or time-delayed failure by fracture of the glass product.

Scratch Resistance. While minimizing fingerprint oil adhesion and increasing the degree in which minimal wiping with a dry cloth can remove the oils, any abrasion of the surface by wiping can generate scratches that induce cosmetic damage and/or contribute to eventual failure of the protective glass cover. High hardness of the glass described herein (higher than for competitive glasses) and high compressive surface DOL (40-60 microns deep, deeper than for competitive glasses) work to prevent damage and to prevent failure from damage that might occur from repeated wiping. As long as the compressive surface's DOL is deeper than damage induced during wiping or during other modes of handling, failure is mitigated.

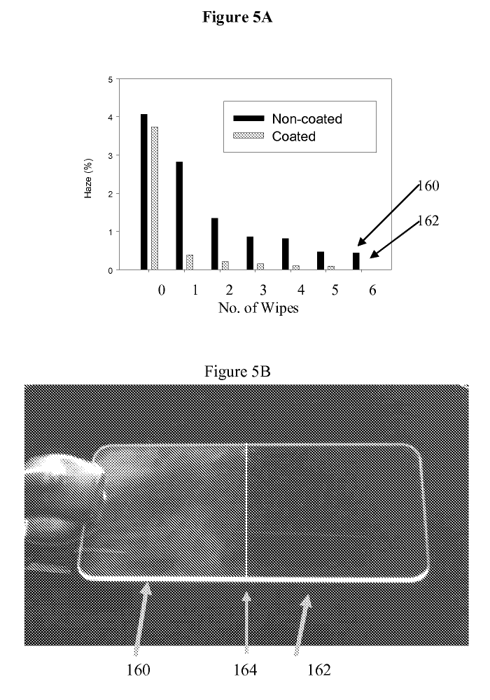

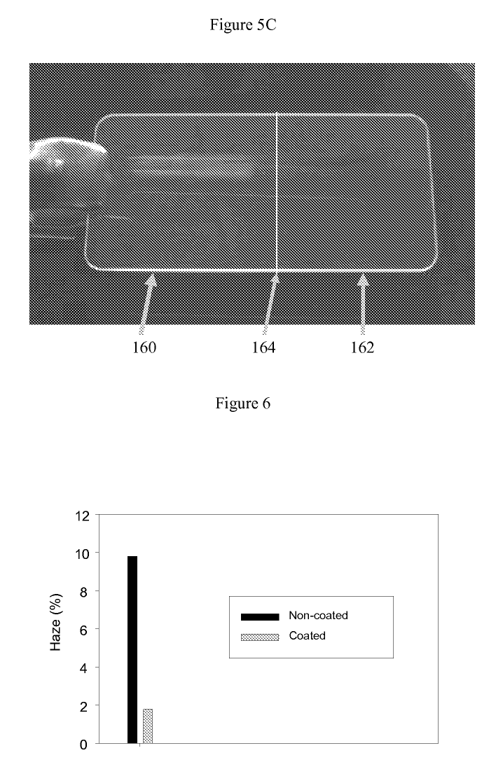

Scratch resistance testing was conducted using a glass article in which one-half of the article's face was amphiphobically coated and the other half was uncoated. The test was a sandpaper scratch test in which the sandpaper (150 grit) was passed across both surfaces using a reciprocating wear instrument such that both sides, coated and uncoated, were subject to equal abrasion. Haze was measured on both areas on both sides of the article, where haze is a measure of optical clarity in terms scattered light versus the sum of all scattered and transmitted light. The results, illustrated in FIGS. 5A, 5B and 5C, and FIG. 6, and discussed below, show that the amphiphobic coating promoted an 80% reduction in haze, that is, optically visible damage to the glass from the abrasion. The results clearly showed that the amphiphobic coating greatly improves scratch resistance.

In addition to scratch resistance the amphiphobic coating lowers the coefficient of friction. Specifically the coefficient of sliding or kinetic friction μ_{K}, as opposed to static friction μ_{S} in which the two objects are not moving, was measured across the coated across a glass article in which one-half of the article's face was amphiphobically coated and the other half was uncoated. The test results indicate that for the uncoated glass μ_{K}=0.25 and for the coated glass μ_{K}=0.05, thus signifying that there is an 80% reduction in kinetic friction due to the presence of the amphiphobic coating. This reduction in friction reduces damage to the glass surface both when a person touches the glass surface, when it is wiped to remove dirt, oils, grease, etc., and when it is placed in a carrying case. This beneficial performance property also enables ease-of-use for touch screen applications.

The following provides additional information relating to the particular alkali aluminosilicate glass suitable for use in the instant embodiment. The glass has a liquidus viscosity of at least 130 kpoise. As used herein, “liquidus viscosity” refers to the viscosity of a molten glass at the liquidus temperature, wherein the liquidus temperature refers to the temperature at which crystals first appear as a molten glass cools down from the melting temperature, or the temperature at which the very last crystals melt away as temperature is increased from room temperature. The glass comprises the following oxides, the concentrations of which are expressed in mole percent (mol %): 64≦SiO₂≦68; 12≦Na₂O≦16; 8≦Al₂O₃≦12; 0≦B₂O₃≦3; 2≦K₂O≦5; 4≦MgO≦6; and 0≦CaO≦5. In addition, 66 mol %≦SiO₂+B₂O₃+CaO≦69 mol %; Na₂O+K₂O+B₂O₃+MgO+CaO+SrO>10 mol %; 5 mol %≦MgO+CaO+SrO≦8 mol %; (Na₂O+B₂O₃)—Al₂O₃≦2 mol %; 2 mol %≦Na₂O—Al₂O₃≦6 mol %; and 4 mol %≦(Na₂O+K₂O)—Al₂O₃≦10 mol %.

The largest single constituent of the alkali aluminosilicate glass is SiO₂, which forms the matrix of the glass and is present in the inventive glasses in a concentration ranging from about 64 mol % up to and including about 68 mol %. SiO₂ serves as a viscosity enhancer that aids formability and imparts chemical durability to the glass. At concentrations that are higher than the range given above, SiO₂ raises the melting temperature prohibitively, whereas glass durability suffers at concentrations below the range. In addition, lower SiO₂ concentrations can cause the liquidus temperature to increase substantially in glasses having high K₂O or high MgO concentrations.

When present in a concentration ranging from about 8 mol % up to and including about 12 mol %, Al₂O₃ enhances viscosity. At Al₂O₃ concentrations that are higher than this range, the viscosity can become prohibitively high, and the liquidus temperature may become too high to sustain a continuous down-draw process. To guard against this, the glasses of the present invention have a total concentration of alkali metal oxides (e.g., Na₂O, K₂O) that is well in excess of the total Al₂O₃ content.

Fluxes are used to obtain melting temperatures that are suitable for a continuous manufacturing process. In the aluminosilicate glass described herein, the oxides Na₂O, K₂O, B₂O₃, MgO, CaO, and SrO serve as fluxes. To satisfy the various constraints on melting, it is preferable that the temperature of the glass at a viscosity of 200 poise is not greater than 1650° C. To achieve this, the condition that Na₂O+K₂O+B₂O₃+MgO+CaO+SrO—Al₂O₃>10 mol % should be met.

Alkali metal oxides serve as aids in achieving low liquidus temperatures, and low melting temperatures. As used herein, the term “melting temperature” refers to the temperature corresponding to a glass viscosity of 200 poise. In the case of sodium, Na₂O is used to enable successful ion-exchange. In order to permit sufficient ion-exchange to produce substantially enhanced glass strength, Na₂O is provided in a concentration ranging from about 12 mol % up to and including about 16 mol %. If, however, the glass were to consist exclusively of Na₂O, Al₂O₃, and SiO₂ within the respective ranges described herein, the viscosity would be too high to be suitable for melting. Thus, other components must be present to ensure good melting and forming performance. Assuming those components are present, reasonable melting temperatures are obtained when the difference between the Na₂O and Al₂O₃ concentrations ranges from about 2 mol % up to and including about 6 mol % (i.e., 2 mol %≦Na₂O—Al₂O₃≦6 mol %).

Potassium oxide (K₂O) is included to obtain low liquidus temperatures. However, K₂O—even more so than Na₂O—can decrease the viscosity of the glass. Thus, the total difference between the sum of the Na₂O and K₂O concentrations and the Al₂O₃ concentration should be in a range from about 4 mol % up to and including about 10 mol % (i.e., 4 mol %≦(Na₂O+K₂O)—Al₂O₃≦10 mol %).

B₂O₃ serves as a flux; i.e., a component added to reduce melting temperatures. The addition of even small amounts (i.e., less than about 1.5 mol %) of B₂O₃ can radically reduce melting temperatures of otherwise equivalent glasses by as much as 100° C. While, as previously mentioned, sodium is added to enable successful ion-exchange, it may be desirable, at relative low Na₂O contents and high Al₂O₃ contents, to add B₂O₃ to ensure the formation of a meltable glass. Thus, in one embodiment, the total concentration of Na₂O and B₂O₃ is linked such that (Na₂O+B₂O₃)—Al₂O₃≦2 mol %. Thus, in one embodiment, the combined concentration of SiO₂, B₂O₃, and CaO ranges from about 66 mol % up to and including about 69 mol % (i.e., 66 mol %≦SiO₂+B₂O₃+CaO≦69 mol %).

When the total alkali metal oxide concentration exceeds that of Al₂O₃, any alkaline earth oxides present in the glass serve primarily as fluxes. MgO is the most effective flux, but is prone to form forsterite (Mg₂SiO₄) at low MgO concentrations in sodium aluminosilicate glasses, thus causing the liquidus temperature of the glass to rise very steeply with MgO content. At higher MgO levels, glasses have melting temperatures that are well within the limits required for continuous manufacturing. However, the liquidus temperature may be too high—and thus the liquidus viscosity too low—to be compatible with a down-draw process such as, for example, the fusion draw process. However, the addition of at least one of B₂O₃ and CaO can drastically reduce the liquidus temperature of these MgO-rich compositions. Indeed, some level of B₂O₃, CaO, or both may be necessary to obtain a liquidus viscosity that is compatible with the fusion process, particularly in glasses having high sodium, low K₂O, and high Al₂O₃ concentrations. Strontium oxide (SrO) is expected to have precisely the same impact on liquidus temperatures of high MgO glasses as CaO. In one embodiment, the alkaline earth metal oxide concentration is thus broader than the MgO concentration itself, such that 5 mol %≦MgO+CaO+SrO≦8 mol %.

Barium is also an alkaline earth metal, and additions of small amounts of barium oxide (BaO) or substitution of barium oxide for other alkaline earths may produce lower liquidus temperatures by destabilizing alkaline-earth-rich crystalline phases. However, barium is considered to be a hazardous or toxic material. Therefore, while barium oxide may be added to the glasses described herein at a level of at least 2 mol % with no deleterious impact or even with a modest improvement to liquidus viscosity, the barium oxide content is generally kept low to minimize the environmental impact of the glass. Thus, in one embodiment, the glass is substantially free of barium.

In addition to the elements described above, other elements and compounds may be added to eliminate or reduce defects within the glass. The glasses of the present invention tend to exhibit 200 kpoise viscosities that are relatively high, between about 1500° C. and 1675° C. Such viscosities are typical of industrial melting processes, and in some cases melting at such temperatures may be required to obtain glass with low levels of gaseous inclusions. To aid in eliminating gaseous inclusions, it may be useful to add chemical fining agents. Such fining agents fill early-stage bubbles with gas, thus increasing their rise velocity through the melt. Typical fining agents include, but are not limited to: oxides of arsenic, antimony, tin and cerium; metal halides (fluorides, chlorides and bromides); metal sulfates; and the like. Arsenic oxides are particularly effective fining agents because they release oxygen very late in the melt stage. However, arsenic and antimony are generally regarded as hazardous materials.

Accordingly, in one embodiment, the glass is substantially free of antimony and arsenic, comprising less that about 0.05 wt % of each of the oxides of these elements. Therefore, it may be advantageous in particular applications to avoid using arsenic or antimony at all, and using instead a nontoxic component such as tin, halides, or sulfates to produce a fining effect. Tin (IV) oxide (SnO₂) and combinations of tin (IV) oxide and halides are particularly useful as fining agents in the present invention.

The glass described herein is down-drawable; that is, the glass is capable of being formed into sheets using down-draw methods such as, but not limited to, fusion draw and slot draw methods that are known to those skilled in the glass fabrication arts. Such down-draw processes are used in the large-scale manufacture of ion-exchangeable flat glass.

The fusion draw process uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank. These outside surfaces extend down and inwardly so that they join at an edge below the drawing tank. The two flowing glass surfaces join at this edge to fuse and form a single flowing sheet. The fusion draw method offers the advantage that, since the two glass films flowing over the channel fuse together, neither outside surface of the resulting glass sheet comes in contact with any part of the apparatus. Thus, the surface properties are not affected by such contact.

The slot draw method is distinct from the fusion draw method. Here the molten raw material glass is provided to a drawing tank. The bottom of the drawing tank has an open slot with a nozzle that extends the length of the slot. The molten glass flows through the slot/nozzle and is drawn downward as a continuous sheet therethrough and into an annealing region. Compared to the fusion draw process, the slot draw process provides a thinner sheet, as only a single sheet is drawn through the slot, rather than two sheets being fused together, as in the fusion down-draw process.

In order to be compatible with down-draw processes, the alkali aluminosilicate glass described herein has a high liquidus viscosity. In one embodiment, the liquidus viscosity is at least 130 kilopoise (kpoise) and, in another embodiment, the liquidus viscosity is at least 250 kpoise.

In one embodiment, the alkali aluminosilicate glass described herein is substantially free of lithium. As used herein, “substantially free of lithium” means that lithium is not intentionally added to the glass or glass raw materials during any of the processing steps leading to the formation of the alkali aluminosilicate glass. It is understood that an alkali aluminosilicate glass or an alkali aluminosilicate glass article that is substantially free of lithium may inadvertently contain small amounts of lithium due to contamination. The absence of lithium reduces poisoning of ion-exchange baths, and thus reduces the need to replenish the salt supply needed to chemically strengthen the glass. In addition, due to the absence of lithium, the glass is compatible with continuous unit (CU) melting technologies such as the down-draw processes described above and the materials used therein, the latter including both fused zirconia and alumina refractories and zirconia and alumina isopipes.

In one embodiment, the glass is chemically strengthened by ion-exchange. As used herein, the term “ion-exchanged” is understood to mean that the glass is strengthened by ion-exchange processes that are known to those skilled in the glass fabrication arts. Such ion-exchange processes include, but are not limited to, treating the heated alkali aluminosilicate glass with a heated solution containing ions having a larger ionic radius than ions that are present in the glass surface, thus replacing the smaller ions with the larger ions. Potassium ions, for example, could replace sodium ions in the glass. Alternatively, other alkali metal ions having larger atomic radii, such as rubidium or cesium could replace smaller alkali metal ions in the glass. Similarly, other alkali metal salts such as, but not limited to, sulfates, halides, and the like may be used in the ion-exchange process. In one embodiment, the down-drawn glass is chemically strengthened by placing it a molten salt bath comprising KNO₃ for a predetermined time period to achieve ion-exchange. In one embodiment, the temperature of the molten salt bath is about 430° C. and the predetermined time period is about eight hours. The chemical strengthening by ion-exchange can be carried out on large pieces of glass which will then be cut (sliced, sawed or otherwise processed) to the size appropriate for the specific application in which it is intended to be used or the strengthening carried out on glass pieces pre-cut to the size appropriate for the intended use.

Down-draw processes produce surfaces that are relatively pristine. Because the strength of the glass surface is controlled by the amount and size of surface flaws, a pristine surface that has had minimal contact with surfaces has a higher initial strength. When this high strength glass is then chemically strengthened, the resultant strength is higher than that of a surface that has been a lapped and polished. Chemical strengthening or tempering by ion-exchange also increases the resistance of the glass to flaw formation due to handling. Accordingly, in one embodiment, the down-drawn alkali aluminosilicate glass has a warpage of less than about 0.5 mm for a 300 mm×400 mm sheet. In another embodiment, the warpage is less than about 0.3 mm.

Surface compressive stress refers to a stress caused by the substitution during chemical strengthening of an alkali metal ion contained in a glass surface layer by an alkali metal ion having a larger ionic radius. In one embodiment potassium ions are substituted for sodium ions in the surface layer of the glass described herein. The glass has a surface compressive stress of at least about 200 MPa. In one embodiment, the surface compressive stress is at least about 600 MPa. The alkali aluminosilicate glass has a compressive stress layer in parted by ion-exchange that has a depth of at least about 20 μm. In one embodiment the compressive stress layer imparted by ion-exchange is in the range of 30-80 μm.

The replacement of smaller ions by larger ions at a temperature below that at which the glass network can relax produces a distribution of ions across the surface of the glass that results in a stress profile. The larger volume of the incoming ion produces compressive stress (CS) on the surface and tension in the center (CT) of the glass. The compressive stress is related to the central tension by the following relationship:

CS=CT×(t−2DOL)/DOL,

where t is the thickness of the glass and DOL is the depth of exchange.

A lithium-free glass having a thickness of at least 0.3 mm, a surface compressive stress of at least about 200 MPa, and a surface compressive layer having a depth of at least about 30 μm is also provided. In one embodiment, the compressive stress is at least about 600 MPa, the depth of the compressive layer is at least about 40 μm, and the thickness of the lithium-free glass is in a range from about 0.7 mm up to about 1.1 mm.

In one embodiment, the lithium-free glass comprises: 64 mol %≦SiO₂≦68 mol %; 12 mol %≦Na₂O≦16 mol %; 8 mol %≦Al₂O₃≦12 mol %; 0 mol %≦B₂O₃≦3 mol %; 2 mol %≦K₂O≦5 mol %; 4 mol %≦MgO≦6 mol %; and 0 mol %≦CaO≦5 mol %, wherein: 66 mol %≦SiO₂+B₂O₃+CaO≦69 mol %; Na₂O+K₂O+B₂O₃+MgO+CaO+SrO>10 mol %; 5 mol %≦MgO+CaO+SrO≦8 mol %; (Na₂O+B₂O₃)—Al₂O₃≦2 mol %; 2 mol %≦Na₂O—Al₂O₃≦6 mol %; and 4 mol %≦(Na₂O+K₂O)—Al₂O₃≦10 mol %, and has a liquidus viscosity of at least 130 kpoise. The liquidus viscosity in one embodiment is at least 250 kpoise.

### Chemically Strengthened Anti-Reflective Amphiphobic Glass

The invention, in another embodiment, relates to a product consisting of a transparent, damage resistant, chemically strengthened protective cover glass that is coated with an antireflective SiO₂ or F—SiO₂ (silica, fused silica or fluorine-doped silica) layer and further has an exterior coating having fluorine termination groups that impart a degree of hydrophobicity and oleophobicity (i.e., amphiphobicity) to the cover glass such that wetting of the glass surface by water and oils is minimized. In addition, the application of the amphiphobic coating to the AR-coated, chemically strengthened glass improves scratch, abrasion, and other damage resistance and further imparts anti-fingerprint, anti-smudge characteristics due to the presence of the fluorine termination groups in the amphiphobic coating that minimizes the transport of oils from finger to the glass (fingerprints) and further allows for ease of removal of the oils/fingerprints by means of wiping with cloth. As used herein, the term “SiO₂ coating” means either a SiO₂ or F—SiO₂ coating or a composite SiO₂/F—SiO₂ coating.

The antireflective and abrasion resistant SiO₂ or F—SiO₂ coating can be placed on the base glass either before or after ion-exchange, preferably. In preferred embodiments the F—SiO₂ coating is placed on base glass that has been ion-exchanged and before the placement of any perfluorocarbon that is used to improve the removal of oils and smudges as from, for example, fingerprints. Perfluorocarbons are used to reduce the surface energy of glass surfaces and this is accomplished as a result of the low polarity of the fluorine terminated surface bond. It is important that the perfluorocarbon coating have sufficient durability when used by a device customer so that this protection last for a sufficient life time, typically at least two years.

A variety of attachment chemistries can be used to attach perfluorocarbon or perfluorocarbon-containing materials to a glass surface. However, glass surfaces that have been chemically strengthened by ion-exchange (e.g., K ions for Na and/or Li ions in a base glass) have a surface that is rich in K ions which limits the number of Si—OH active surface sites and this inhibits the covalent bonding a perfluorocarbon or perfluorocarbon-containing moiety to surface of the ion-exchanged glass. One benefit of applying a SiO₂ or F—SiO₂ coating is the enhanced Si-termination sites that are present on a SiO₂ or F—SiO₂ coated chemically strengthened glass versus a chemically strengthened glass without the coating that has an alkali-rich ion-exchanged surface. As a result of the SiO₂ or F—SiO₂ coating over the chemically strengthened glass surface the bonding of perfluorocarbon or perfluorocarbon containing moieties is enhanced and the surface density of the covalently bonded perfluorocarbon or perfluorocarbon containing moieties is increased. The outermost fluorinated species generate the “Anti-Fingerprint” or “Easy-to-Clean” properties of the cover glass without loss of glass strength resulting from the chemical strengthening. In addition, the SiO₂ or F—SiO₂ coating, by itself or in conjunction with additional layer of SiO₂ or F—SiO₂ and another metal oxide film (a multilayer coating that can have sequential layers of SiO₂ and/or F—SiO₂ and/or “other metal oxides”) can act as an anti-reflective coating. Examples of such “other metal oxides” include, for example, HfO₂, TiO₂, ZrO₂, Y₂O₃, Gd₂O₃, and other metal oxides known in the art to be useful for anti-reflective coatings. Additionally, MgF₂ can be used as an anti-reflective layer and can be applied to chemically strengthened glass. The perfluorocarbon containing moieties can then be applied to the anti-reflective coating. The resulting coated, chemically strengthened glass has enhanced damage resistance, anti-reflection and amphiphobic properties, and thus provides a scratch resistance surface that exhibits minimal optical interference from reflected light and fingerprints. This combination of properties for hand-held display devices, high compressive surface DOL glass coated to be amphiphobic and also anti-reflective due to the presence of an anti-reflective coating, has not been met by other glass materials used in such devices.

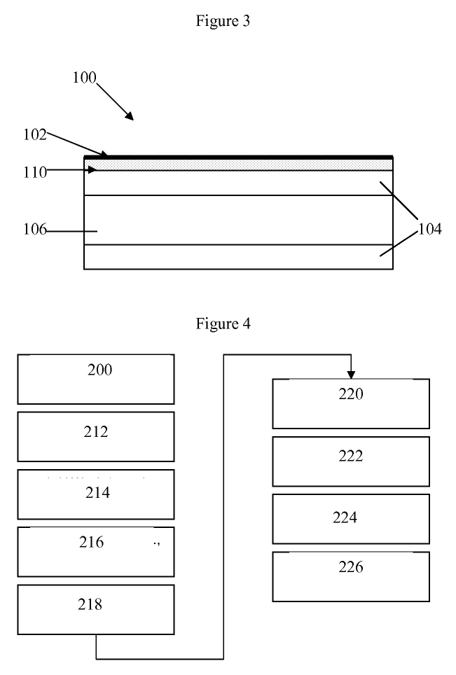

FIG. 3 specifically illustrates an alkali aluminosilicate glass article 100 having a surface compressive layer 104 formed by ion-exchange, a compressive strength of at least 200 MPa, a non-ion-exchanged middle portion 106, an anti-reflective coating 110 and a amphiphobic fluorine-based surface layer 102. The surface compressive layer 104 has a depth in the range of 20-70 μm. The glass article, exclusive of the antireflective layer 110 and the fluorine-based surface layer 102, has a thickness comprised of the ion-exchanged layer(s) 104 and the middle layer 106. In some embodiments the thickness is at least 0.3 mm.

The anti-reflective coating layer 110 is comprised of at least one layer and has a thickness in the range of 10-70 μm. When the antireflective coating is comprised of two or more layers the total thickness of the anti-reflective coating is also in the range of 10-70 μm. The fluorine-based amphiphobic layer typically has a thickness in the range of 1-10 nm, preferably in the range of 1-4 nm. In one embodiment the amphiphobic coating has a thickness in the range of 1-2 nm. When a single anti-reflective layer is used the coating material is SiO₂ or F—SiO₂. When a multilayer anti-reflective coating is used the layer closest to layer 104 is a metal oxide layer selected from the group HfO₂, TiO₂, ZrO₂, Y₂O₃, Gd₂O₃, and other metal oxides known in the art to be useful for anti-reflective coatings, and the top layer is SiO₂ or F—SiO₂. When the antireflective coating is three or more layers, the topmost layer is SiO₂ or F—SiO₂ and the antireflective coating layers between the top SiO₂ or F—SiO₂ layer and layer 104 can be any of the foregoing anti-reflective coating materials in any order, though in preferred embodiments the first layer is a metal oxide layer. For example, a 3-layer coating can be glass-Y₂O₃—TiO₂—SiO₂.

The chemically strengthened, anti-reflective, amphiphobic glass has the following advantages over present commercially available cover glasses.
1. The anti-reflective coating applied to the base glass prior to treatment with a fluorine containing amphiphobic-imparting moiety acts to present optical interference due to reflection, thus eliminating glare. The anti-reflective coating is versatile and its performance includes controlling the angle of optical interference (or visibility) and thus provides an option for a “privacy” effect by means of structuring a multi-layer coating that enhances this effect.
2. After the anti-reflective coated is treated with a fluorine-containing moiety the resulting surface is non-polar, minimizing hydrogen (that is, Van der Walls) bonding between foreign particles and oils and the treated glass surface. The resulting treated surface has a very low surface energy and a low coefficient of friction. The effect and performance of the placement of fluorine-containing moieties as the final “coating” is of added benefit to anti-reflection coatings and surfaces because the elimination of glare means that any noticeable fingerprints become the only source of optical interference, and these can be wiped away.
3. Fingerprint removal is typically carried out under either wet or dry conditions by wiping the surface with a cloth. These cloths are often reused and contain dirt and particles that scratch the surface. The fluorinated surface enhances the ease of fingerprint removal while minimizing smudges and reducing the number and frequency of events that cause damage which in turn can lead to either immediate or pre-mature failure through fracturing of the glass.
4. The scratch resistance of the glass is also improved. The high hardness of the chemically strengthened glass and its high compressive surface DOL (for example, 30-80 μm deep) work to both prevent damage and prevent failure from damage that might occur through repeated wiping. Scratch resistance was then measured using a glass article one-half of which was coated with an amphiphobic coating and the other half uncoated. Scratching was performed as described above. Haze was then measured on both areas on both sides of the article, where haze is a measure of optical clarity in terms scattered light versus the sum of all scattered and transmitted light. The test results indicate that for the uncoated glass μ_{K}=0.25 and for the coated glass μ_{K}=0.05, thus signifying that there is an 80% reduction in kinetic friction due to the presence of the amphiphobic coating. The coefficient of kinetic friction, μ_{K}, was also measured. An 80% reduction in friction was found for the coated side versus the uncoated side.

### Surface Activation by Acid Treatment

In a further embodiment of the invention the surface of a chemically strengthened glass is surface activated by acid treatment prior to application of an amphiphobic coating. As has been described above, in accordance with the invention a pristine drawn glass is chemically strengthened by ion-exchange to a depth of at least 30 μm using cations larger than the cations in the as-drawn glass. For example, Na or Li ions a drawn glass can be ion-exchanged using K ion. This exchange imparts a compressive strength to the glass as has been explained above. However, the chemically strengthened glass has a surface that is rich in potassium ions and it is believed that this limits the Si—OH active surface sites to which an amphiphobic coating can be covalent attached, thus inhibiting the bonding of an amphiphobic material such as R_{F}C(O)Cl, (R_{F})₂SiCl₂ or (R_{F})₃SiCl, or other coating materials, to the glass surface. It has been found that acid treatment of the ion-exchanged glass prior to application of the amphiphobic coating enhances the adhesion of the amphiphobic coating to the glass and improves both the wettability and wipability of the glass.

The acid treatment is carried out such that the ions that have been chemically exchanged into the glass are removed to a selected depth, a depth whereby the mechanical performance of the chemically strengthened glass (for example, strength, scratch resistance, impact damage resistance) is not affected. For example, as indicated herein the ion-exchange of K ions for Na and/or Li ions is carried out such that the exchange is accomplished to a depth of at least 20 μm, preferably to a depth in the range of 30-80 μm. The acid treatment is carried out such that only K ions near the surface of the ion-exchanged glass are removed, typically to a depth in the range of ≦50 nm.

In a preferred embodiment the acid treatment removes the exchanged ion (K ions exchanged for Na and/or Li ions in the base glass) to a depth in the range of 5-15 nm (0.005-0.015 nm). For example, a glass 0.3 mm (300 μm) thick is ion-exchanged by immersion in an ion-exchange bath using K ions as the exchanging ion for Na and/or Li ions, the immersion being for a sufficient time such that ion-exchange is carried out to a depth of 50 μm with K ions replacing the Na and/or Li ions. The resulting exemplary glass, viewed through its thickness on the side, would have two surface ion-exchanged layers of 50 nm thickness and a non-exchanged layer of 200 μm sandwiched between the two ion-exchanged layers. Acid treatment is then carried out such that the exchanged K ions are removed to a depth of 10 nm (0.01 μm), a depth that does not effect the mechanical performance of the glass. After acid treatment the glass, viewed from one face to another through its thickness, has a first 0.01 μm non-K layer, a first 49.9 μm K-exchanged layer, a 200 μm non-exchanged central layer, a second 49.9 μm K-exchanged layer and an second 0.01 μm non-K layer. Alternatively, one side of the ion-exchanged glass can be covered with a protective layer and acid treated such that K-ions are removed from only one side. After removal of the K-ions, one K-ion removed side is coated with an amphiphobic coating or it can be coated with an anti-reflective coating followed by coating with an amphiphobic coating. The acids used in treating the glass are generally strong acids, for example without limitation, sulfuric acid, (H₂SO₄), hydrochloric acid (HCl), perchloric acid (HClO₄), nitric acid (HNO₃), and other strong acids known in the art. Additional acids that can be used are phosphoric acid (H₃PO₄), acetic acid (CH₃COOH) and perfluoroacetic acid (CF₃COOH).

FIG. 4 is a schematic illustrating the generic process flow for preparing glass surfaces for coating with an amphiphobic layer, including an acid treating step, if desired, and also for inspecting and testing the integrity and durability of the amphiphobic coating. Generally, acid treatment was carried out using 0.3-0.5 molar sulfuric acid solution for a time in the range of 5-15 minutes at room temperature (approximate range of range of 18-30° C.).

Table 1 shows the performance data for commercially available Corning Code 1317 glass coated the alkoxysilyl perfluoropolyether DC2604 [an (R_{f})ₙSiX₄₋ₙ compound as described herein], with and without acid treatment as described therein. The contact angles were measured for both water and sebaceous oil (used as substitute for actual fingerprint oil). While the contact angle for both was found to increase after acid treatment, the durability of the coating, as determined by wiping tests using a reciprocating wear test machine using a load of ˜1.5 PSI and up to 10,000 wipe passes, was not adversely affected by the acid treatment. The durability of both the acid treated and untreated glass surfaces coated with the sebaceous oil survived 10,000 rubbing wipes at 1.5 psi and 60 Hz using a mechanical rubbing device. The rubbing was done using a woven cotton fabric. There was little or no change in the contact angles after wiping.

TABLE 1

| Pre-coating data | Without acid treatment | Acid treatment |
|---|---|---|
| Initial Haze (%) | 0.00 | 0.00 |
| Initial | water = 93.4 ± 1.3° | water =109.2 ± 5.4° |
| Contact Angles | Sebaceous oil = | Sebaceous oil = |
| | 72.0 ± 2.8° | 81.2 ± 0.9° |
| Post - 10K Haze | 0.00 | 0.00 |
| Post -10K Contact Angle | water = 91.2 ± 1.7° | water = 104.6 ± 1.7° |
| (with water) | Sebaceous oil = | Sebaceous oil = |
| | 72.0 ± 2.8° | 80.4 ± 1.9° |

1. Glass is Corning Code 1317 (CC 1317) commercial glass coated with DC 2604.
2. Acid treatment is a 10 minute soak in 0.367M H₂SO₄ at ~21° C.
3. Sebaceous oil is also called fingerprint oil.

FIG. 5A illustrates the wiping performance to reduce haze and thus improve optical clarity for CC 1317 glass coated with DC 2604 versus non-coated glass. Initially both surfaces exhibited negligible haze (≦0.03%, not illustrated). After coating with fingerprint oil (0 wipes) the haze for both coated and non-coated surfaces was approximately the same (˜3.8% and 4%, respectively). However, after wiping the coated glass shows a much faster recovery of optical clarity (haze reduction) than does the non-coated glass. After the 6^{th} wipe the coated glass exhibits complete recovery (arrow 162 indicating no measurable haze) whereas the non-coated glass still shows ˜0.5% haze (arrow 160). FIG. 5B is a photograph of the glass of FIG. 5A after it has undergone the 6^{th} wipe. The glass is held above the background by means of a clamp at the left (unnumbered). In FIG. 5B numeral 160 represents the uncoated side and numeral 162 represents the coated side, with the line of numeral 164 designating the separation between the two sides. FIG. 5C is a photograph of a glass that has been abraded across its entire face using 150 grit sandpaper. In FIG. 5C numeral 160 shows abrasion on the uncoated side due to the sandpaper whereas coated side 160 shows no abrasion and remains clear. Numeral 164 indicates the separation between the two sides and the glass is held above the background by means of a clamp on the left (unnumbered).

FIG. 6 illustrates the haze (loss of optical clarity) generated by abrasion with 150 grit sandpaper using coated glass and non-coated glass. One half of a glass sample was coated with an amphiphobic coating and 50/50 cured (50/50=50° C. and 50% moisture for 2 hours and then rinsed to remove unbound coating) and the other half was uncoated. The sample was then abraded across both the coated and non-coated surfaces. The data indicates that the non-coated surface had ˜9.8% haze and the coated surface has ˜1.76% haze, respectively. Coating thus represents a 75% reduction in haze generated by scratching damage over the non-coated surface. In FIG. 4 the even numerals 210-226 have the meanings as shown in Table 3.

TABLE 3

| Numeral | Meaning |
|---|---|
| 210 | Machined or otherwise finished parts received |
| 212 | Ultrasonic clean parts with high pH detergent |
| 214 | Optional: acid wash for 10 min. stagnant in 0.35M H₂SO₄ |
| 216 | O₂plasma clean for 10 min @ 400 watts |
| 218 | Dip-coat or Vapor coat with fluorocarbon coating |
| 220 | Cure the coating (time, temperature, humidity) |
| 222 | Inspect for haze, contact angle, sliding angle |
| 224 | Test Durability (10,000 wipes) |
| 226 | Re-inspect (haze, contact angle, sliding angle) |

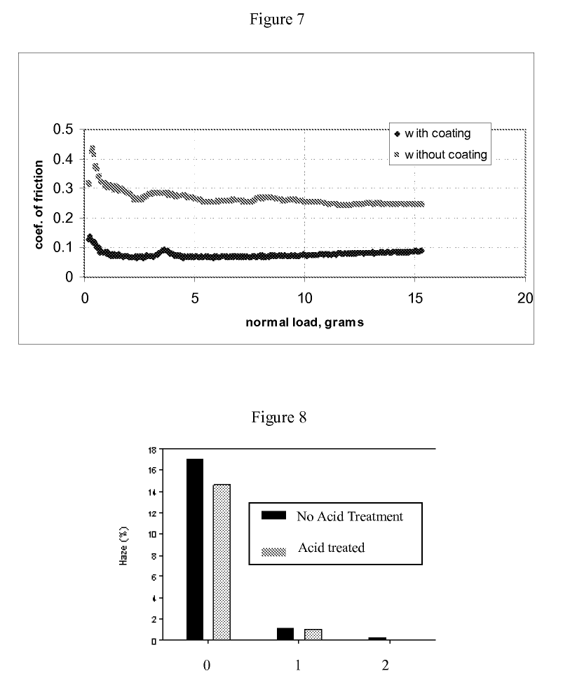

FIG. 7 Illustrates the kinetic coefficient of friction, pK, of CC 1317, DC 2604 coated and non-coated surfaces. The friction testing was carried out using “ball-on-flat” sliding contact with a sapphire ball and a steady speed of 20 mm/s with and increasing load of 0.2 to 15.4 grams over a 2.0 mm distance. The data indicates that use of the coating results in >60% reduction in μ_{K} over the non-coated glass.

FIG. 8 is a bar chart for a chemically strengthened CC 1317 glass sample one-half of which was treated with acid (standing in 0.35 sulfuric acid solution) and one-half not acid treated. After acid treatment the glass was rinsed and plasma treated and then the entire surface was coated with an amphiphobic coating followed by treatment with fingerprint oil after the coating was cured (50/50 curing). The data at 0 wipes shows haze levels of 17% and 14% for the non-coated and coated surfaces, respectively, A single wipe decreases the haze to ˜1.3% and 1% for the uncoated and coated surfaces, respectively, Two wipe reduces the haze for the uncoated surface to ˜0.2% and 0% for the coated surface. These results indicated that acid treatment prior to coating with an amphiphobic material greatly improves the wiping performance which improvement is believed due to increased adherence of the amphiphobic coating to the surface of the glass.

The coated cover plates as described herein had a sliding angle of less than 10° for fluid substances placed thereon. Table 2 shows the contact angles and sliding angles for water, hexadecane and sebaceous oil for glass surfaces having a perfluorocarbon coating as described herein. The contact angles varied between 115° and 65° according to substance and the sliding arranged from 1° to 9° according to the substance.

TABLE 2

| Substance | Contact Angle | Sliding Angle |
|---|---|---|
| Water | 115° | 9° |
| Hexadecane | 65° | 1° |
| Sebaceous Oil | 73° | 3° |

When a liquid droplet is placed on a solid flat surface and it does not completely spread out over the surface, a “contact angle” is formed. The contact angle is defined as the angle on the liquid side of the tangential line drawn through the three phase boundary when a liquid, gas and solid intersect. The contact angle is a quantitative measure of the wetting of a solid by a liquid and there are commercially available instruments for measuring contact angles. Contact angles are generally measured for non-stick coatings to estimate their surface energy. Using water as an example, when the surface energy is low the contact angle is high, meaning that the liquid does not wet the surface. In addition to the contact angle, the “sliding angle” of a liquid droplet on a solid surface can also be determined. To determine the sliding angle a liquid droplet is placed on a flat solid surface and the solid surface is slowly tilted. The droplet will at first lean forward and, as the surface if further tilted, will eventually slide downward. The tilt of the solid when the droplet begins sliding downward if the “sliding angle”.

### Back-Side Protection

In a further embodiment of the invention back-side (or device component side) protection for the glass articles of the invention is provided during the processes described herein. Back-side protection protects the side of the glass that will not be “touched” by the user of an article having an amphiphobic, chemically strengthened glass cover face as has been described herein. Since the back-side of the glass will not be touched, but will be adjacent to the components in which the cover glass is used, coating is not necessary.

Backside protection can be accomplished by the use of use of “tapes or films” or “paper/non-adhesive films” which are applied to the glass. The “tape or film” process uses a laminate material that is both resistant to dissolution during the amphiphobic coating process and is removable in alcohols (methanol, ethanol, isopropanol, etc.) or ketones (acetone, methyl ethyl ketone and similar ketonic solvents). Acrylic adhesive laminates are exemplary materials that can be applied as films and used to protect one side during dip or thermal evaporation techniques and which are resistant to the amphiphobic coating, but the adhesive layer is soluble in acetone. Polyimides, polyesters, polyethylenes and polyethylene terephthalate (PET) are examples of tape/film backing materials and then coupled with an acrylic adhesive or modified acrylic adhesive they can be applied to the backside of the glass. The tapes/films have an adhesive on one side which permits the tape to be removed after application of the amphiphobic coating to the front or user side of the glass article. Preferred are tapes/films that can be die cut and laminated to the glass surface using a commercial laminator. After the backside-protected glass article has been coated with the amphiphobic coating the tape is removed, for example, by peeling. After the tape has been removed any residual adhesive is removed by application of an appropriate solvent that removes the adhesive without affecting the amphiphobic coating. Typically the coating is not soluble in the same solvents that will remove the tape residue.

Paper/non-adhesive films can also be used for backside protection. For example, dry or wet paper or can be pressed between two articles prior to, for example, dipping the parts into a bath containing the amphiphobic coating. When paper is used for backside protection a preferred method is to lay the paper (preferably wetted by a liquid that does not contain the amphiphobic material) on a surface and lay the glass article on top of the paper. The amphiphobic coating, either neat or in a solvent, is then applied to the exposed surface of the article. The use of a wetted paper prevents the amphiphobic coating from passing between the glass and the paper.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

1. An alkali aluminosilicate glass article comprising a base alkali aluminosilicate glass having a length, a width and a thickness, a surface compressive stress of at least about 200 MPa, a surface compressive layer depth in the range of 20-80 μm, and having an amphiphobic fluorine-based surface layer chemically bonded to the surface of the glass article to form a coated glass article,

2. The glass article according to claim 1, wherein the bonded fluorine-based surface layer is selected from the group consisting of:
(1) silica —OH group terminated active surface sites exchanged with a fluorine-based monomer;
(2) an assembled monolayer of a fluorine-terminating molecular chain;
(3) a thin, fluoro-polymeric coating;
(4) silicon compound of general formula (R_{F})ₙSiX₄₋ₙ, where R_{F} is a perfluorocarbon moiety, X is selected from the group consisting of a non-fluorine halogen and a C₂-C₆ alkoxy group, and n is in the range of 1-3; and
(5) silica soot particles which have previous derived with or treated to have fluorine termination groups.

3. The glass article according to claim 1, wherein said coated glass article has a sliding angle of less than 10° for fluid substances placed thereon

4. The alkali aluminosilicate glass article according to claim 1 wherein the glass article further comprises a textured or patterned surface layer between the base glass and the amphiphobic fluorine-based surface layer, said amphiphobic fluorine-based surface layer being bonded to the textured or patterned surface layer and any untextured or unpatterned base glass surface; and
wherein said textured surface has a roughness in the range of 50 nm to 5 μm.

5. The alkali aluminosilicate glass article according to claim 1, wherein the compressive stress is at least about 600 MPa, the depth of surface compressive layer is at least 40 μm, and the thickness is in a range from about 0.7 mm up to about 1.1 mm.

6. The alkali aluminosilicate glass article according to claim 1, wherein the glass comprises:
64 mol %≦SiO₂≦68 mol %;
12 mol %≦Na₂O≦16 mol %;
8 mol %≦Al₂O₃≦12 mol %;
0 mol %≦B₂O₃≦3 mol %;
2 mol %≦K₂O≦5 mol %;
4 mol %≦MgO≦6 mol %; and
0 mol %≦CaO≦5 mol %,
wherein:
66 mol %≦SiO₂+B₂O₃+CaO≦69 mol %;
Na₂O+K₂O+B₂O₃+MgO+CaO+SrO>10 mol %;
mol %≦MgO+CaO+SrO≦8 mol %;
(Na₂O+B₂O₃)—Al₂O₃≦2 mol %;
2 mol %≦Na₂O—Al₂O₃≦6 mol %; and
4 mol %≦(Na₂O+K₂O)—Al₂O₃≦10 mol %, and
wherein the glass has a liquidus viscosity of at least 130 kpoise.

7. The alkali aluminosilicate glass article according to claim 1, wherein the glass has an anti-reflective coating thereon and the anti-reflective coating is selected from the group consisting of silica, fused silica, F-doped fused silica, HfO₂, TiO₂, ZrO₂, Y₂O₃, and Gd₂O₃.

8. An alkali aluminosilicate glass article comprising an alkali aluminosilicate glass having a length, a width and a thickness of at least 0.3 mm, a surface compressive stress of at least about 200 MPa, a surface compressive layer depth in the range of 20-70 μm in which K ions have replaced Na and/or Li ions in the glass, and having an amphiphobic fluorine-based surface layer chemically bonded to a surface of the glass article;
wherein the outer surface of said glass to a depth of <50 nm is an acid etched surface depleted of the exchanged K ions prior to application of fluorine-based surface layer to the surface of the glass.

9. The alkali aluminosilicate glass article according to claim 8, wherein the bonded fluorine-based surface layer is based on a compound of formula (R_{F})ₙSiX₄₋ₙ, where R_{F} is a C₁-C₂₂ alkyl perfluorocarbon, n is an integer in the range of 1-3, and X is a hydrolyzable group that has exchanged with the glass terminal OH groups, and thickness of the fluorine-based surface layer is in the range of 1-10 nm.

10. The alkali aluminosilicate glass article according to claim 8, wherein X is selected from the group consisting of a halogen other than fluorine and an alkoxy group (—OR), where R is a linear or branched hydrocarbon of 1-6 carbon atoms.

11. The alkali aluminosilicate glass article according to claim 8, wherein the compressive stress is at least 600 MPa, the depth of surface compressive layer prior to treatment is at least 40 μm, and the thickness of the glass article is in the of 0.7 mm to 1.1 mm.

12. The alkali aluminosilicate glass article according to claim 8, wherein the glass comprises:
64 mol %≦SiO₂≦68 mol %;
12 mol %≦Na₂O≦16 mol %;
8 mol %≦Al₂O₃≦12 mol %;
0 mol %≦B₂O₃≦3 mol %;
2 mol %≦K₂O≦5 mol %;
4 mol %≦MgO≦6 mol %; and
0 mol %≦CaO≦5 mol %,
wherein:
mol %≦SiO₂+B₂O₃+CaO≦69 mol %;
Na₂O+K₂O+B₂O₃+MgO+CaO+SrO>10 mol %;
5 mol %≦MgO+CaO+SrO≦8 mol %;
(Na₂O+B₂O₃)—Al₂O₃≦2 mol %;
2 mol %≦Na₂O—Al₂O₃≦6 mol %; and
4 mol %≦(Na₂O+K₂O)—Al₂O₃≦10 mol %, and
wherein the glass has a liquidus viscosity of at least 130 kpoise.

13. An alkali aluminosilicate glass article, said article comprising
a glass substrate having a length, a width and a thickness of at least 0.3 mm, a surface compressive stress of at least about 200 MPa, a surface compressive layer having a depth of at least between about 20-70 μm;
an anti-reflective coating on one surface of said glass; and
an amphiphobic fluorine-based surface layer chemically bonded to the surface of the anti-reflective coating
wherein the glass comprises:
64 mol %≦SiO₂≦68 mol %;
12 mol %≦Na₂O≦16 mol %;
8 mol %≦Al₂O₃≦12 mol %;
0 mol %≦B₂O₃≦3 mol %;
2 mol %≦K₂O≦5 mol %;
4 mol %≦MgO≦6 mol %; and
0 mol %≦CaO≦5 mol %,
wherein:
66 mol %≦SiO₂+B₂O₃+CaO≦69 mol %;
Na₂O+K₂O+B₂O₃+MgO+CaO+SrO>10 mol %;
5 mol %≦MgO+CaO+SrO≦8 mol %;
(Na₂O+B₂O₃)—Al₂O₃≦2 mol %;
2 mol %≦Na₂O—Al₂O₃≦6 mol %; and
4 mol %≦(Na₂O+K₂O)—Al₂O₃≦10 mol %, and
wherein the glass has a liquidus viscosity of at least 130 kpoise.

14. The alkali aluminosilicate glass article according to claim 13, wherein the anti-reflective coating is selected from the group consisting of silica, fused silica, F-doped fused silica and MgF₂; and
wherein the thickness of the antireflective coating is in the range of anti-reflective coating is in the range of 10-60 μm.

15. The alkali aluminosilicate glass article according to claim 13, wherein the anti-reflective coating is selected from the group consisting of HfO₂, TiO₂, ZrO₂, Y₂O₃, and Gd₂O₃, and the thickness of the antireflective coating is in the range of anti-reflective coating is in the range of 10-60 μm.

16. The alkali aluminosilicate glass article according to claim 13, wherein the bonded fluorine-based surface layer is selected or formula (R_{F})ₙSiX₄₋ₙ, where R_{F} from the group consisting of where R_{F} is a C₁-C₂₂ alkyl perfluorocarbon, n is an integer in the range of 1-3, and X is a hydrolyzable group that can be exchanged with the glass terminal OH groups.

17. The alkali aluminosilicate glass article according to claim 13, wherein X is selected from the group consisting of a halogen other than fluorine and an alkoxy group (—OR), where R is a linear or branched hydrocarbon of 1-6 carbon atoms.

18. The alkali aluminosilicate glass article according to claim 13, wherein the compressive stress is at least about 600 MPa, the depth of surface compressive layer, prior to treatment is at least 40 μm, and the thickness is in a range from about 0.7 mm up to about 1.1 mm.

19. A method of making coated alkali aluminosilicate glass article anti-fingerprint and anti-smudge characteristics, said method comprising the steps of:
providing an alkali aluminosilicate glass substrate having a length, width and thickness;
chemically strengthening the surface of the glass substrate to a depth in the range of 20-80 μm;
machining or otherwise finishing the glass surfaces;
ultrasonically cleaning the glass surfaces;
optionally, acid washing at least one surface of the glass using a solution of a strong acid,
plasma cleaning the at least one surface of the glass using O₂;
optionally, coating the class with an anti-reflective coating;
coating cleaned glass surface or the anti-reflecting coating surface with an amphiphobic coating,
curing the amphiphobic coating for a selected time at a selected temperature and a selected humidity; and
inspecting the coated alkali aluminosilicate glass article.

20. The method according to claim 19, wherein coating the glass with an anti-reflective coating means coating with an anti-reflective coating material selected from the group consisting of silica, fused silica and F-doped fused silica.

21. The method according to claim 19, wherein coating the glass with an anti-reflective coating means coating with an anti-reflective coating material selected from the group consisting of HfO₂, TiO₂, ZrO₂, Y₂O₃, and Gd₂O₃.

22. The method according to claim 19, wherein coating the glass with an amphiphobic coating means coating with an amphiphobic coating material of formula (R_{F})ₙSiX₄₋ₙ, where R_{F} from the group consisting of where R_{F} is a C₁-C₂₂ alkyl perfluorocarbon, n is an integer in the range of 1-3, and X is a hydrolyzable group that can be exchanged with the glass terminal OH groups; and
wherein X is selected from the group consisting of a halogen other than fluorine and an alkoxy group (—OR), where R is a linear or branched hydrocarbon of 1-6 carbon atoms.
